(19) United States
(12) Patent Application Publication
(10) Pub. No.: US 2026/0016039 A1
(43) Pub. Date: Jan. 15, 2026

(54) Breakout Adapter

(71) Applicant: Illinois Tool Works Inc., Glenview, IL (US)

(72) Inventor: Eric Kato, Naperville, IL (US)

(21) Appl. No.: 19/261,209

(22) Filed: Jul. 7, 2025

Related U.S. Application Data
(60) Provisional application No. 63/671,337, filed on Jul. 15, 2024.

(51) Int. Cl. F16B 21/08; F16B 5/06

(52) U.S. Cl. CPC F16B 21/084; F16B 5/065

(57) ABSTRACT

An adapter to attach a fastener assembly to a component that has a breakout opening. The adapter includes an annular body with a central opening, both of which can have a discorectangular shape (a rectangular shape with rounded ends). Attached to the underside of the annular body are several flexible retention arms. Each arm has a stepped outer surface with at least three levels that help it grip the side of the breakout opening. Among these arms, one can have a straight surface, and another can have a curved surface. The arms are designed to fit at least partly through the breakout opening to hold the adapter securely to the component.

### RELATED APPLICATION

The present application claims priority to U.S. Provisional Patent Application No. 63/671,337, filed Jul. 15, 2024, and entitled “Breakout Adapter,” which is hereby incorporated by reference in its entirety.

### BACKGROUND

Automotive components require fastening techniques that are simple to manufacture and assemble. Further, fastening techniques should above all be reliable and efficient. In some instances, objects need to be secured to the vehicle to mitigate movement and/or shifting during operation, which can result in damage or kinking to the object. For example, tubes, hoses, wires, and other objects are often secured to the vehicle components via fasteners.

Conventional fastening or assembly systems often require attachment with a breakout opening in a component, which are not always configured to accommodate traditional fasteners. Therefore, it would be desirable to provide an adapter to couple traditional fasteners with certain openings in components.

### SUMMARY

The present disclosure relates generally to an adapter forming a connection between an opening (e.g., a breakout opening) in a component and a fastener, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates an exploded assembly view of a fastening system with an adapter in accordance with an aspect of the present disclosure.

FIG. 1b illustrates a partially assembled view of the fastening system of FIG. 1a.

FIG. 1c illustrates an assembled view of the fastening system of FIG. 1a.

FIG. 1d illustrates an assembled view of the fastening system of Figure in which the fastener assembly is locked to the adapter with the component is omitted for illustrative clarity.

FIG. 2a illustrates a topside perspective view of the adapter of FIGS. 1a through 1d.

FIG. 2b illustrates an underside perspective view of the adapter.

FIG. 2c illustrates a top plan view of the adapter.

FIG. 2d illustrates a bottom plan view of the adapter.

FIG. 2e illustrates a first side elevation view of the adapter.

FIG. 2f illustrates a second side elevation view of the adapter.

FIG. 2g illustrates a third side elevation view of the adapter.

FIG. 2h illustrates a fourth side elevation view of the adapter.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

In one example, an adapter for securing a fastener assembly having a fastener to a component having a breakout opening comprises: an annular body defining a central adapter opening sized to receive the fastener, where each of the annular body defining and the central adapter opening is discorectangular in shape; and a plurality of retention arms resiliently coupled to the annular body and extending from an underside surface of the annular body, wherein each of the plurality of retention arms defines a stepped profile along an outer surface of the retention arm that includes at least three axially aligned steps configured to engage a sidewall of the breakout opening, wherein the plurality of retention arms comprises a first retention arm having a surface profile that is straight and a second retention arm having a surface profile that is curved, and wherein the plurality of retention arms is configured to insert at least partially through the breakout opening to secure with the component.

In another example, an adapter for securing a fastener assembly having a fastener to a component having a breakout opening comprises: an annular body defining a central adapter opening sized to receive the fastener; and a plurality of retention arms resiliently coupled to the annular body and extending from an underside surface of the annular body, wherein each of the plurality of retention arms defines a stepped profile along an outer surface of the retention arm configured to engage a sidewall of the breakout opening, and wherein the plurality of retention arms is configured to insert at least partially through the breakout opening to secure with the component.

In yet another example, a fastening system for securing a payload to a component having a breakout opening comprises: a fastener assembly having a fastener and configured to secure the payload; and an adapter comprising an annular body defining a central adapter opening sized to receive the fastener, and a plurality of retention arms resiliently coupled to the annular body and extending from an underside surface of the annular body, wherein each of the plurality of retention arms defines a stepped profile along an outer surface of the retention arm configured to engage a sidewall of the breakout opening, and wherein the plurality of retention arms is configured to insert at least partially through the breakout opening to secure with the component.

In some examples, the stepped profile includes a plurality of steps configured to engage sidewalls of different panel thicknesses.

In some examples, each of the plurality of retention arms defines a chamfered or sloped leading end surface to guide the retention arm into the breakout opening during assembly.

In some examples, the annular body is a discorectangular shape.

In some examples, the central adapter opening is a discorectangular shape.

In some examples, the stepped profile includes at least three axially aligned steps.

In some examples, the annular body comprises two parallel linear sections and two opposed curved sections, each of the two parallel linear sections and the two opposed curved sections comprising at least one of the plurality of retention arms.

In some examples, the plurality of retention arms comprises a first retention arm having a surface profile that is straight and a second retention arm having a surface profile that is curved.

In some examples, the plurality of retention arms comprises a first set of opposed retention arms having surface profiles that are straight and a second set of opposed retention arms having surfaces profiles that are curved.

In some examples, the plurality of retention arms is arranged symmetrically about the central adapter opening.

In some examples, the fastener is a tree-style fastener.

In some examples, the fastener assembly further comprises a strap tie including a strap portion and a ratchet assembly.

In some examples, the ratchet assembly is positioned adjacent the fastener with an annular flange disposed therebetween.

In some examples, each of the plurality of retention arms is coupled to the annular body via a living hinge.

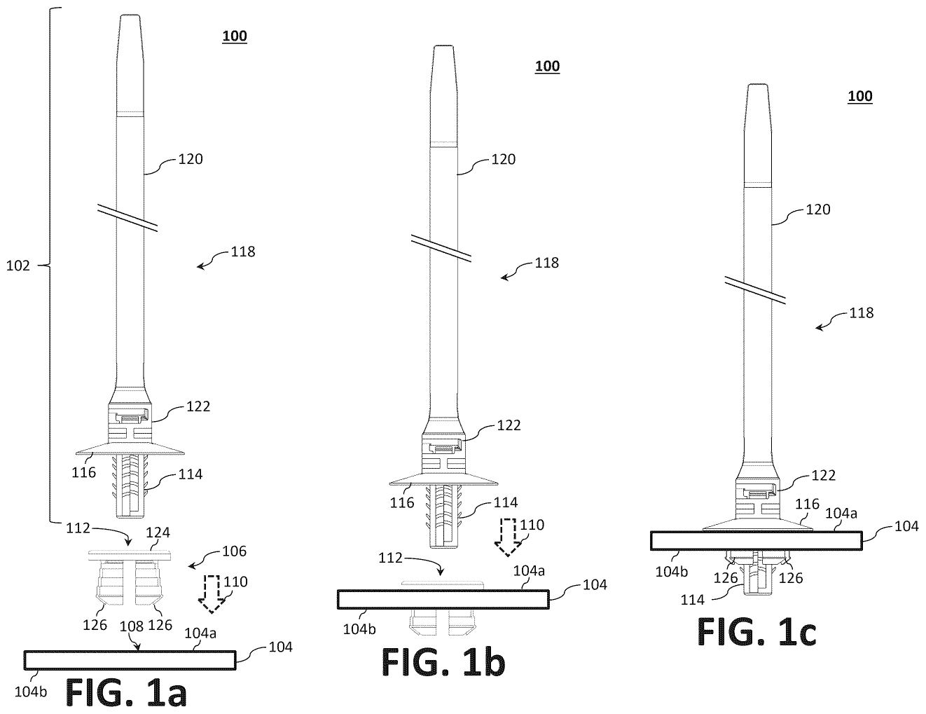

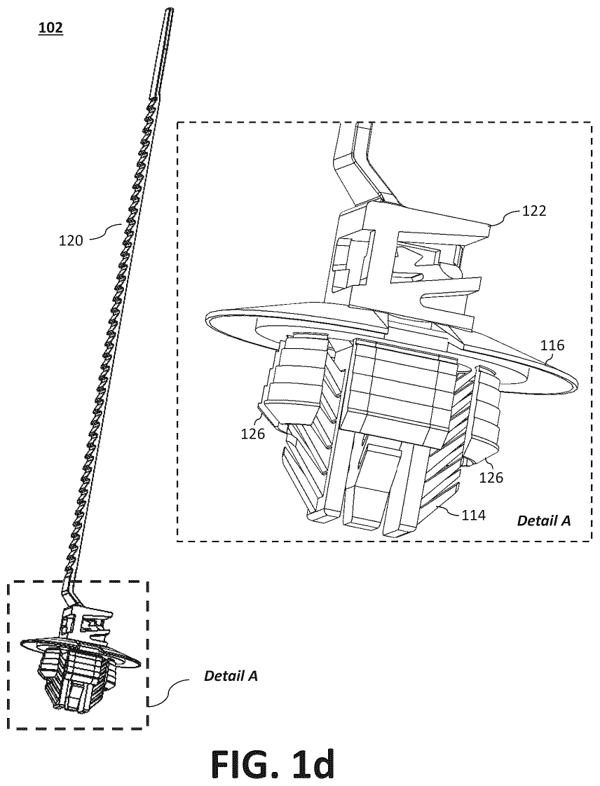

FIGS. 1a through 1d illustrate a fastening system 100 that includes a fastener assembly 102, a component 104, and an adapter 106 configured to mount the fastener assembly 102 to the component via a breakout opening 108 formed in the component 104. FIG. 1a illustrates an exploded assembly view of the fastening system 100. FIG. 1b shows an assembly view in which the adapter 106 is moved in the direction of arrow 110 and inserted into the breakout opening 108. FIG. 1c illustrates an assembly view where the adapter 106 remains installed in the component 104 and the fastener assembly 102 is moved in the direction of arrow 110 and inserted into an adapter opening 112 of the adapter 106. FIG. 1d illustrates a perspective view of the fastener assembly 102 coupled to the adapter 106, with the component 104 omitted for illustrative clarity. Details of the assembly between the fastener assembly 102 and the adapter 106 are seen in Detail A.

The illustrated fastener assembly 102 includes a fastener 114, an annular flange 116, and a strap tie 118. While the fastener 114 is illustrated as a tree-style fastener, other fasteners are contemplated. The strap tie 118 includes a strap portion 120 and a ratchet assembly 122 for receiving and locking the strap portion 120. The ratchet assembly 122 is positioned adjacent to the fastener 114 with the flange 116 disposed therebetween. During installation, the strap portion 120 is looped around a payload (e.g., tube, wire bundle, etc.), with its free end fastened using a ratchet assembly 122. Suitable ratchet assemblies 122 may include ratcheting mechanisms, latches, snaps, clips, hook-and-loop fasteners, or cable ties (e.g., zip ties). This configuration allows for payload management integrated with mechanical panel attachment.

While a single strap tie 118 is illustrated, additional or fewer strap ties 118 may be used depending on design requirements and the number of payloads to be secured. The dimensions of the fastener assembly 102 can be modified to accommodate the necessary number of strap ties 118 or payloads. Although described in the context of securing a payload in the form of a tube, the fastener assembly 102 may be used to attach various other objects.

The component 104 includes an A-side surface 104a (e.g., exterior surface) and a B-side surface 104b (e.g., interior surface). The one or more payloads are mounted to the A-side surface 104a via the fastener assembly 102. The component 104 may comprise structural or body elements of a vehicle—such as doors, pillars (A-, B-, or C-pillars), dashboard components, seat frames, center consoles, fenders, sheet metal framework, or similar elements. The component 104 defines the breakout opening 108 configured to receive and retain the fastener assembly 102.

A breakout opening 108 generally refers to a cutout or knock-out panel opening found in sheet metal, plastic, enclosure components, or the like. The breakout opening 108 is an aperture formed during material removal, often by punching. Breakout openings 108 can be used to provide access for cables, connectors, fasteners, ventilation, future modifications, etc. Breakout openings 108 are often pre-scored or partially cut, allowing them to be more easily removed without the need for additional tools. A breakout opening 108 can produce, however, a reverse burr on the exit side of the material. For example, during manual removal (e.g., punching out a knock-out panel in metal), sharp edges or burs can remain on one side of the component 104 at a perimeter (or portion thereof) of the breakout opening 108, which is more likely in thicker or harder materials (like steel).

Traditional fasteners cannot easily engage such openings from the punch-exit side, which is often the accessible face during installation. The adapter 106 overcomes this by being installable from the reverse side, allowing engagement of reverse-burred edges without requiring rework or excessive insertion force.

Depending on the application, the component 104 may be formed from metal (e.g., hardened steel), metal alloys, synthetic or semi-synthetic polymers (e.g., ABS or PVC), composite materials (e.g., fiberglass), or combinations thereof. The breakout opening 108 may be at least partially formed during manufacturing (or prior to assembly) and can be discorectangular, though other geometries—such as circular, oval, triangular, or other quadrilateral openings—are also contemplated. The breakout opening is formed in the component, such as a high-strength steel panel, typically by punching, and produces a reverse burr condition that complicates standard fastener installation. The adapter 106 enables secure mechanical engagement despite this burr geometry and accommodates a variety of fastener sizes and panel thicknesses.

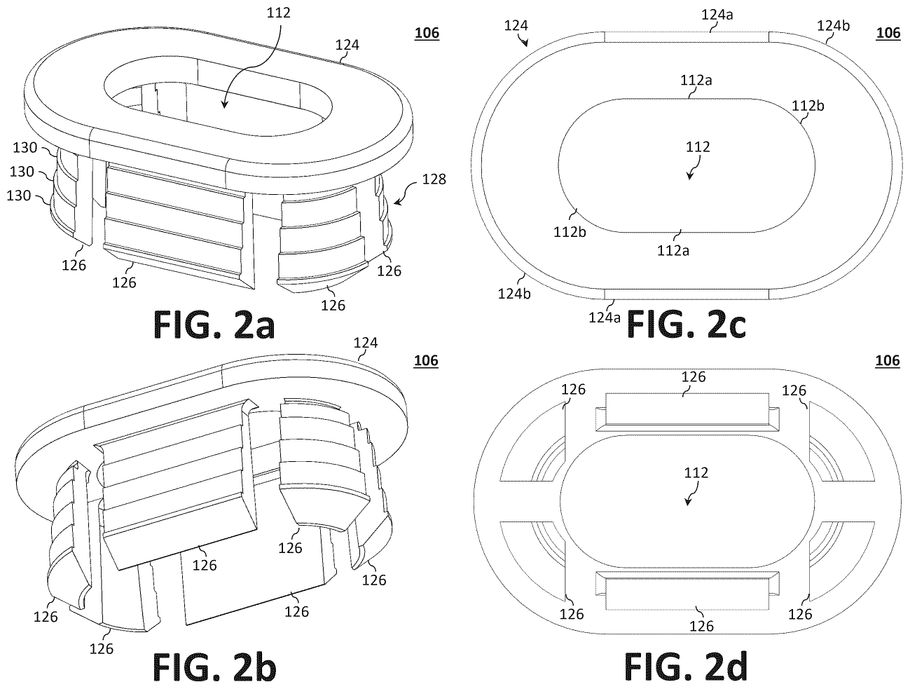

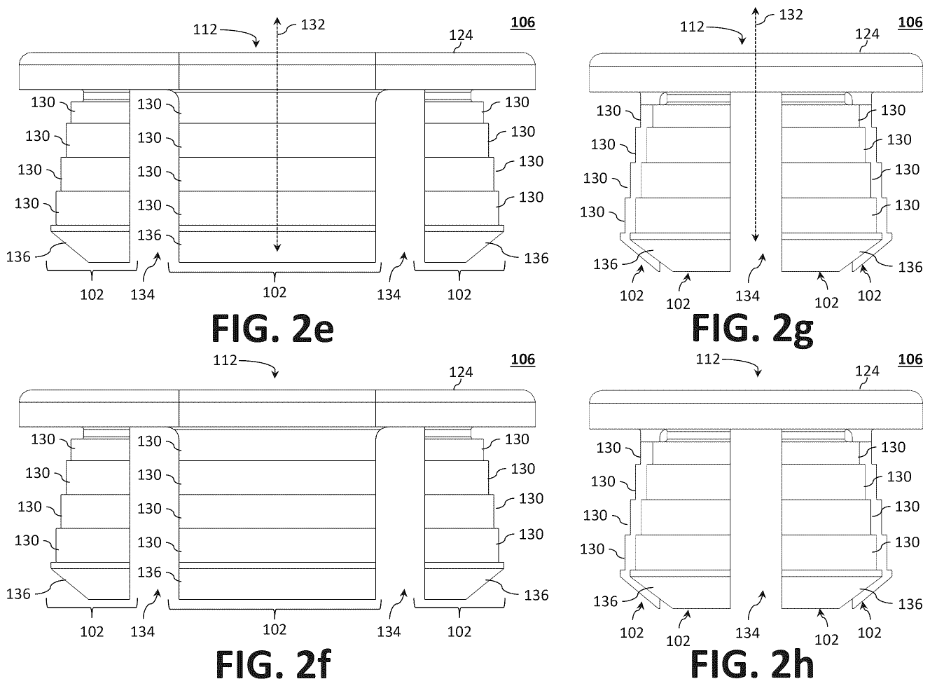

Details of the adapter 106 are illustrated in greater detail in FIGS. 2a through 2h, which collectively depict various views and structural features of the adapter 106 that enable it to interface effectively with both the component 104 and the fastener assembly 102. FIG. 2a illustrates a topside perspective view of the adapter 106, which illustrates its annular body 124 (e.g., ring- and central adapter opening 112. FIG. 2b shows an underside perspective view, where multiple retention arms 126 extending from the bottom surface of the annular body 124 are visible. FIG. 2c presents a top plan view of the adapter 106, showing its generally discorectangular outer profile with elongated linear sides and opposing semicircular end portions. FIG. 2d illustrates a bottom plan view, emphasizing the radial symmetry and spacing of the retention arms 126 around the opening 112. FIGS. 2e and 2f depict first and second side elevation views of the adapter 106, corresponding to opposing long sides, while FIGS. 2g and 2h illustrate third and fourth side elevation views, corresponding to the opposing short sides.

The annular body 124 may be shaped in various forms, including rectangular, elliptical, or polygonal configurations, depending on the geometry of the breakout opening 108 and mating fastener assembly 102. In the illustrated embodiment, the adapter 106 is discorectangular, which offers a balance of torsional rigidity and manufacturability. The central adapter opening 112 is dimensioned to receive the fastener 114 of the fastener assembly 102 in a friction-fit or snap-in manner, optionally incorporating internal ribs, grooves, or ledges to guide and secure the fastener upon insertion.

The retention arms 126 are configured to deform inwardly during insertion into the breakout opening 108 and expand outwardly upon clearing the reverse burr created during punching. Each retention arm 126 is integrally connected to the annular body 124 via a living hinge or compliant flexure zone, allowing resilient movement. In some examples, the retention arms 126 are spaced about by a gap 134. The retention arms 126 may number between three and eight, with four shown in the illustrated embodiment. The spacing and angle of each arm may be adjusted to tailor insertion forces and retention strength. For example, in alternative embodiments, the retention arms 126 may include curved or arcuate profiles to further conform to varying burr geometries or nonuniform panel thicknesses.

Each retention arm 126 includes a stepped outer surface profile 128 comprising multiple engagement shoulders or steps 130, which provide discrete detent positions for locking into panels of different thicknesses. Four steps 130 are illustrated, although more or fewer may be provided. In some examples, the stepped outer surface profile 128 includes at least three axially aligned steps 130. That is, the steps 130 are aligned with the center axis 132.

The distal end of each arm includes a chamfered lead-in surface 136 to facilitate insertion, reduce the risk of damage to the component 104, and ease installation despite the presence of reverse burrs. The flared distal ends of the retention arms 126 may be angled outwardly by approximately 5 to 15 degrees (typically around 10 degrees) relative to the central axis 132 of the adapter, ensuring a gradual insertion profile and controlled retention force.

In some embodiments, the retention arms 126 may include textured surfaces, serrations, or embedded metal or fiber reinforcements to enhance grip and mechanical locking with the panel. Alternatively, the adapter 106 may incorporate active features such as integral barbs, locking tabs, twist-lock mechanisms, or dual-stage arms that engage sequentially during insertion. Additionally, a sealing feature (e.g., an elastomeric ring or flange gasket) may be included to provide dust or water ingress protection where the adapter 106 penetrates a sealed compartment or weather-exposed area.

In alternate designs, the adapter 106 may be configured with a split body or hinged clamshell construction, enabling it to open during installation and close around the breakout opening 108. Such variants are useful for retrofitting into existing systems or accommodating particularly large burrs or variable opening geometries. Detachable or replaceable retention arms may also be provided to enable field service or part repair.

Details of the adapter 106 are illustrated in greater at FIGS. 2a through 2h. Specifically, FIGS. 2a through 2h collectively illustrate various views of the adapter 106. Specifically, FIG. 2a illustrates a topside perspective view of the adapter 106, while FIG. 2b presents an underside perspective view. FIG. 2c illustrates a top plan view of the adapter 106, and FIG. 2d provides a bottom plan view. FIG. 2e illustrates a first side elevation view of the adapter 106, corresponding to a first long side, and FIG. 2f illustrates a second side elevation view representing the second long side. FIG. 2g illustrates a third side elevation view of the adapter 106, corresponding to a first short side, and FIG. 2h illustrates a fourth side elevation view, showing the second short side of the adapter 106.

The adapter 106 is configured to couple with the fastener assembly 102 and to secure the fastener assembly 102 relative to the component 104. The adapter 106 includes an annular body 124 defining a central adapter opening 112 and a plurality of retention arms 126 extending from the underside of the annular body. In the illustrated example, the annular body is discorectangular in shape, having a rectangular profile with opposing semicircular ends. In other words, a discorectangular shape has two parallel linear sections 124a and two opposed curved sections 124b (e.g., semicircular, semioval, etc.).

The central adapter opening 112 can be the same shape or different from the shape of the annular body 124. In the illustrated example, the central adapter opening 112 is discorectangular and has two parallel linear sections 112a and two opposed curved sections 112b.

Other shapes are possible. The retention arms are distributed around the perimeter of the body and extend in a direction generally perpendicular to the body's plane. Each retention arm is connected to the annular body via a living hinge or similar flexure joint, allowing it to deform inwardly during insertion and spring outward afterward to provide secure mechanical retention.

The outer surface of each retention arm includes a stepped profile 128. This stepped profile includes a plurality of steps 130 (four are shown), which define successive shoulder surfaces for engaging differently sized panel thicknesses. This multi-step geometry ensures that the adapter 106 can be retained in panels having a range of thicknesses without compromising stability. The distal end of each retention arm includes a chamfered or angled leading end surface 136 to guide insertion and minimize interference with burrs or panel edges. The leading end of the adapter 106 is also outwardly flared to assist with alignment and installation. For example, the outer surface of the retention arms 126 can flare outward by about 5 to 15 degrees, or about 10 degrees, relative to the central axis 132.

The adapter 106 is dimensioned to accommodate smaller fasteners than the breakout opening. For example, it can interface a 6.5 mm×12.5 mm fastener into a 12 mm×17 mm breakout opening, or a 9 mm×17 mm fastener into the same breakout. This compatibility enables the reuse of legacy breakout tooling while accommodating new fastener types. The adapter 106 thus serves as an interface that reduces cost, enhances versatility, and supports both legacy and forward-looking design requirements.

As best illustrated in FIG. 2d, the retention arms 126 on the long sides have inner and outer surface profiles that are straight (corresponding to the linear portions of the discorectangular shape) and the retention arms 126 on the short sides have inner and outer surface profiles that are curved (corresponding to the curved portion of the discorectangular shape).

The fastener assembly 102 and adapter 106 may each be formed as unitary components using plastic injection molding or additive manufacturing. In additive examples, components may be fabricated via fused deposition modeling (FDM), stereolithography (SLA), selective laser sintering (SLS), or other 3D printing methods, offering precision and flexibility, particularly for complex geometries and low-volume production.

Additive manufacturing processes consider horizontal resolution (X-Y plane) and vertical resolution (Z-axis layer thickness). Horizontal resolution typically ranges from 50-100 μm (510-250 DPI), while vertical resolution can range from 16-100 μm (1,600-250 DPI). Higher resolutions yield finer detail but increase production time. Different portions of the fastener assembly 102 may be printed at different resolutions based on functional or design needs.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. An adapter for securing a fastener assembly having a fastener to a component having a breakout opening, the adapter comprising:
an annular body defining a central adapter opening sized to receive the fastener, where each of the annular body defining and the central adapter opening is discorectangular in shape; and
a plurality of retention arms resiliently coupled to the annular body and extending from an underside surface of the annular body,
wherein each of the plurality of retention arms defines a stepped profile along an outer surface of the retention arm that includes at least three axially aligned steps configured to engage a sidewall of the breakout opening,
wherein the plurality of retention arms comprises a first retention arm having a surface profile that is straight and a second retention arm having a surface profile that is curved, and
wherein the plurality of retention arms is configured to insert at least partially through the breakout opening to secure with the component.

2. An adapter for securing a fastener assembly having a fastener to a component having a breakout opening, the adapter comprising:
an annular body defining a central adapter opening sized to receive the fastener; and
a plurality of retention arms resiliently coupled to the annular body and extending from an underside surface of the annular body,
wherein each of the plurality of retention arms defines a stepped profile along an outer surface of the retention arm configured to engage a sidewall of the breakout opening, and
wherein the plurality of retention arms is configured to insert at least partially through the breakout opening to secure with the component.

3. The adapter of claim 2, wherein the stepped profile includes a plurality of steps configured to engage sidewalls of different panel thicknesses.

4. The adapter of claim 2, wherein each of the plurality of retention arms defines a chamfered or sloped leading end surface to guide the retention arm into the breakout opening during assembly.

5. The adapter of claim 2, wherein the annular body is a discorectangular shape.

6. The adapter of claim 2, wherein the central adapter opening is a discorectangular shape.

7. The adapter of claim 2, wherein the stepped profile includes at least three axially aligned steps.

8. The adapter of claim 2, wherein the annular body comprises two parallel linear sections and two opposed curved sections, each of the two parallel linear sections and the two opposed curved sections comprising at least one of the plurality of retention arms.

9. The adapter of claim 2, wherein the plurality of retention arms comprises a first retention arm having a surface profile that is straight and a second retention arm having a surface profile that is curved.

10. The adapter of claim 2, wherein the plurality of retention arms comprises a first set of opposed retention arms having surface profiles that are straight and a second set of opposed retention arms having surfaces profiles that are curved.

11. The adapter of claim 2, wherein the plurality of retention arms is arranged symmetrically about the central adapter opening.

12. The adapter of claim 2, wherein the fastener is a tree-style fastener.

13. The adapter of claim 2, wherein the fastener assembly further comprises a strap tie including a strap portion and a ratchet assembly.

14. The adapter of claim 13, wherein the ratchet assembly is positioned adjacent the fastener with an annular flange disposed therebetween.

15. The adapter of claim 2, wherein each of the plurality of retention arms is coupled to the annular body via a living hinge.

16. A fastening system for securing a payload to a component having a breakout opening, the fastening system comprising:
a fastener assembly having a fastener and configured to secure the payload; and
an adapter comprising:
an annular body defining a central adapter opening sized to receive the fastener, and
a plurality of retention arms resiliently coupled to the annular body and extending from an underside surface of the annular body,
wherein each of the plurality of retention arms defines a stepped profile along an outer surface of the retention arm configured to engage a sidewall of the breakout opening, and
wherein the plurality of retention arms is configured to insert at least partially through the breakout opening to secure with the component.

17. The fastening system of claim 16, wherein the fastener assembly comprises an annular flange and a strap tie.

18. The fastening system of claim 17, wherein the annular flange is positioned between the fastener and the strap tie.

19. The fastening system of claim 16, wherein the stepped profile includes a plurality of steps configured to engage sidewalls of different panel thicknesses.

20. The fastening system of claim 16, wherein each of the plurality of retention arms defines a chamfered or sloped leading end surface to guide the retention arm into the breakout opening during assembly.
